(19) United States
(12) Patent Application Publication
(10) Pub. No.: US 2007/0011238 A1
(43) Pub. Date: Jan. 11, 2007

(54) Communication device and method

(76) Inventors: Noam Rechter, Shoshanat Ha' Amakim (IL); Aaron Nahumi, Tel Aviv (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/440,503

(22) Filed: May 24, 2006

(30) Foreign Application Priority Data
May 26, 2005 (IL) 168,827

(51) Int. Cl. G06F 15/16

(52) U.S. Cl. 709/204

(57) ABSTRACT

There is provided a device for establishing a meeting of minds in a system consisting of a plurality of such devices, including a transceiver for entering and storing data concerning a participant, forming a first message and/or at least one goal, forming at least one second message, and a processor for comparing the data of the second message received by the transceiver with the goal as entered and stored, forming the second message. The processor actuates an output signal when the data of the received second message and goal are substantially identical. A method for establishing a meeting of minds, is also provided.

### FIELD OF THE INVENTION

The present invention relates to a system and a method for enabling people to make contact with another or others for specific reasons or purposes, at a certain time and/or place, in order to communicate and/or otherwise to establish contact with one or more people for the same and/or different reasons or purposes.

### BACKGROUND OF THE INVENTION

Wherever people gather, whether in the same place or not and with or without distance limitations, namely, in contact in public or global arenas, gatherings, such as in public, in private or in other places, whether located on the ground, in the air, or traveling by sea, in schools, clubs (sports or other clubs), workplaces, pleasure and entertainment places, supermarkets, shopping centers, restaurants, hospitals, theaters, etc., hereinafter referred to as “the arena”. Those who are present, individuals or a specific group or any other entity, such as a company selling a product or service, hereinafter “participant” or “participants”, may use different technological methods, including but not limited to, the provision and/or receiving of data and details retrieved from a distance, including via the Internet, through the use of static or portable instruments and/or apparatus that are, either permanently or temporarily located and/or installed in the arena, in order to contact others to establish a meeting of minds, i.e., meeting of wishes, purposes, etc. between one participant (who wishes to propose and/or provide and/or receive and/or seek and/or purchase) and another (who wishes to propose and/or provide and/or receive and/or seek and/or purchase) in connection with a specific location (fixed or movable such as a transport vehicle), instrument product, service or aim, hereinafter “the goal”, which may be constituted by one or more, fixed or changeable goals. For various reasons, such as Tabu, embarrassment, discretion or secrecy, the participants frequently refrain from or are unable to take any action toward establishing a meeting of minds, or are prevented from doing so in an efficient manner, if at all. At present, no method or means exist for automatically establishing a meeting of minds, when the participants are in one or more arena.

### DISCLOSURE OF THE INVENTION

It is therefore a broad object of the present invention to provide a device and a method for automatically or semi-automatically establishing a meeting of minds.

It is a further object of the invention to provide a system and a method for establishing an on-line or off-line meeting of minds.

It is still a further object of the invention to provide a system and a method for establishing a meeting of minds in one or more arena.

Yet a further object of the invention is to provide a system and method for discretely establishing a meeting of minds.

In accordance with the present invention there is therefore provided a device for establishing a meeting of minds in a system including a plurality of such devices, comprising a transceiver having means for entering and storing data concerning a participant, forming a first message and/or at least one goal, forming at least one second message, and a processor for comparing the data of at least a second message received by the transceiver with the goal as entered and stored, forming said second message and for actuating an output signal when the data of said received second message and goal are substantially identical.

The invention further provides a method for establishing a meeting of minds, comprising providing a plurality of devices each including a transceiver having means for entering and storing data concerning a participant, forming a first message and/or at least one goal, forming at least one second message; a processor for comparing the data of at least a second message received by the transceiver with the goal as entered and stored forming said second message and for actuating an output signal when the data of said received second message and goal are substantially identical; transmitting said second message in a selected arena; awaiting receipt of a substantially identical second message from a participant present in the same arena, and selectively responding to said participant upon receiving an actuating signal.

### BRIEF DESCRIPTION OF THE DRAWINGS

The invention will now be described in connection with certain preferred embodiments with reference to the following illustrative figure, so that it may be more fully understood.

With specific reference now to the figure in detail, it is stressed that the particulars shown are by way of example and for purposes of illustrative discussion of the preferred embodiments of the present invention only, and are presented in the cause of providing what is believed to be the most useful and readily understood description of the principles and conceptual aspects, of the invention. In this regard, no attempt is made to show structural details of the invention in more detail than is necessary for a fundamental understanding of the invention, the description taken with the drawing making apparent to those skilled in the art how the several forms of the invention may be embodied in practice.

In the drawing:

FIG. 1 is a schematic illustration of an embodiment of the device, according to the present invention.

### DETAILED DESCRIPTION OF PREFERRED EMBODIMENTS

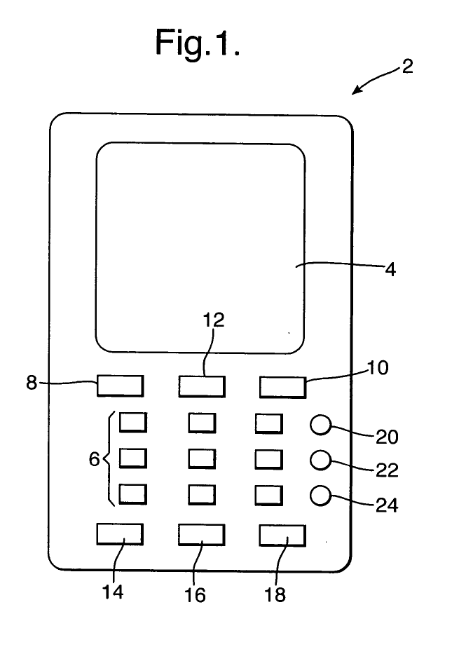

There is illustrated in FIG. 1 an embodiment of a device 2 according to the present invention. The device 2, which can be designed in any convenient configuration, is basically a transceiver, similar to a cellular phone or a beeper, or a portable computer such as a PalmR. The device can operate via wires, or preferably be wireless. It consists of a display 4, a standard array of keys 6 for entering (into a memory not shown) indicia, i.e., letters, numbers and symbols, a key 8 for entering and storing a first message concerning data relating to the participant holder of a specific device 2, a key 10 for entering and storing at least one second message concerning at least one goal, a key 12 for transmitting at least one second message and selectively also the entered first message. There are also provided further operating keys 14 for actuating a voice response, 16 for operating a video response and 18, for operating a palpating response. Obviously, a combination of the actuation of several responses can also be effected. Other standard operating keys 20, 22, 24, such as ON/OFF, retransmit, select, record, etc., may also be provided.

The manner of operating a system including several participants each equipped with a device 2, whether possessed or owned by the participant or allocated to the participant upon entering an arena, is as follows:

A participant or the service provider in an arena will feed the device with at least one goal or several goals. Optionally, the participant's personal data profile, constituting a first message, will also be entered into the device. The goal, which constitutes the second message, will be comprised of factual, descriptive, emotional or other profiles and parameters and data relating to the participant and/or the requested participants, according to the participant's choice(s), all or partially personally determined by the participant, or as predetermined by the service provider. A closed and/or open list of profiles and parameters may be supplied within the device. For example, if a participant wishes to establish a permanent relationship with other participant(s), the following parameters will be given with regard to the participant himself and with regard to the other participants with whom the participant wishes to establish the meeting of minds: sex, age, family status, children, education, profession, residence, height, weight, general description, hobbies, preferences, etc. The participant may be active and/or passive, namely waiting for a signal from another participant, and/or active, namely, attempting to locate another participant or participants where a meeting of minds exists.

A participant can simultaneously indicate a number of goals and can decide, unless the service provider decides otherwise and sets limitations or obligations, whether to allow all or some of them to be activated, when and how, and to what distance, according to the boundaries the participant sets for each arena.

The meeting of minds will be established as long as the goal of one participant is identical or similar, random or otherwise, to that of another participant or participants in the arena, according to the definitions of the messages.

If a meeting of minds is established, a signal, e.g., an audio, visual or physical signal, whether descriptive, factual or otherwise and whether personal or relating to objects carried by a participant, such as clothes, jewelry etc., inter alia, by means of photos, icons, ringing, lights or vibrations, SMS messages, or e-mails can be sent from one participant to the other through the device and, if applicable, a physical meeting or another agreed upon way is arranged in order to reach the meeting of minds. A number of meetings of minds may be established for the same goal, in the same arena, at the same time or at “sequential times”. The participant could then decide which of the responding participants to prefer and which to eliminate, in accordance with the goal, or according to principles that will be determined by the initiating participant, or by the service provider, and how to approach the other participant(s) and/or goals.

The meeting of minds can also be established via an additional self-powered, or otherwise, instrument worn by the participants and actuated by the subject device. The instrument could be configured, as could the device itself, in a way to be comfortably, discreetly carried by a participant in or on the body. For example, such an instrument may provide vibrations at any preset frequency and intensity upon being actuated. The frequency and intensity will be governed by the signals transmitted by the device, as adjusted by the participants. For this purpose, the instrument will include a receiver for receiving output signals from the device and accordingly actuate a palpating member. The vibrations applied to a specific organ of the body may instigate personal, subjective secondary sensations, feelings or perceptions, which can more precisely transmit or convey the sender's emotions or state of mind, resulting in a more intense meeting of minds.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A device for establishing a meeting of minds in a system including a plurality of such devices, comprising:
a transceiver having means for entering and storing data concerning a participant, forming a first message and/or at least one goal, forming at least one second message, and
a processor for comparing the data of at least a second message received by the transceiver with the goal as entered and stored, forming said second message and for actuating an output signal when the data of said received second message and goal are substantially identical.

2. The device as claimed in claim 1, wherein said transceiver is constituted by a device selected from the group of devices at least similar to cellular phones, beepers, a transmitter and a receiver and a portable computer.

3. The device as claimed in claim 1, wherein said output signal is selected from the group of audible, visual or palpating signals or a combination thereof.

4. The device as claimed in claim 1, wherein said transceiver is wireless or communicates by means of wires.

5. The device as claimed in claim 1, further comprising a self-powered instrument configured to be comfortably worn on or in the body, which instrument consists of a receiver for receiving output signals from said transceiver and for actuating corresponding palpating signals.

6. The device as claimed in claim 1, wherein the frequency and amplitude of said output signals are adjustable.

7. A method for establishing a meeting of minds, comprising:
providing a plurality of devices each including a transceiver having means for entering and storing data concerning a participant, forming a first message and/or at least one goal, forming at least one second message; a processor for comparing the data of at least a second message received by the transceiver with the goal as entered and stored forming said second message and for actuating an output signal when the data of said received second message and goal are substantially identical;
transmitting said second message in a selected arena;
awaiting receipt of a substantially identical second message from a participant present in the same arena, and
selectively responding to said participant upon receiving an actuating signal.

8. The method as claimed in claim 7, comprising transmitting said first message and said second message.

9. The method as claimed in claim 7, comprising:
awaiting receipt of a substantially identical second message and a first message of a participant, and
perusing said first message before electing to respond.

10. The method as claimed in claim 7, further comprising providing an instrument configured to be comfortably worn on or in the body, which instrument consists of a receiver for receiving output signals from said transceiver and for actuating corresponding palpating signals, adjusting said device to emit output signals of a set frequency and amplitude and transmitting same to said instrument.
